(19) United States
(12) Patent Application Publication
(10) Pub. No.: US 2021/0281155 A1
(43) Pub. Date: Sep. 9, 2021

(54) REVERSE GENERATOR

(71) Applicants: Edgar Enrique DIAZ RAMIREZ, Santiago (CL); Rafael SANCHEZ, Miami, FL (US); Hunaldo Humberto MARTINEZ VILLALOBOS, Santiago (CL)

(72) Inventors: Edgar Enrique DIAZ RAMIREZ, Santiago (CL); Rafael SANCHEZ, Miami, FL (US); Hunaldo Humberto MARTINEZ VILLALOBOS, Santiago (CL)

(21) Appl. No.: 17/187,965

(22) Filed: Mar. 1, 2021

Related U.S. Application Data
(60) Provisional application No. 62/986,203, filed on Mar. 6, 2020.

(51) Int. Cl. H02K 21/30; H02K 5/10; H02K 7/18; F03D 9/25; F03B 13/00

(52) U.S. Cl. CPC H02K 21/30; H02K 5/10; H02K 7/1823; F05B 2220/706; F03D 9/25; F03B 13/00; H02K 7/183

(57) ABSTRACT

An reverse electric power generator includes a longitudinal stator and a longitudinal rotor, in which the rotor surrounds the stator in an axial direction such that the rotor rotates relative to the axis for inducing an electrical current in the stator.

### CROSS-REFERENCE TO RELATED APPLICATION

This application claims priority to U.S. Provisional Patent Application No. 62/986,203 filed Mar. 6, 2020, the entirety of which is hereby incorporated by reference.

### BACKGROUND OF THE INVENTION

Electric generators are well-known devices that function based on the Faraday principle, namely, moving a magnet inside a stationery coil of wire makes (induces) an electric current to flow in the wire.

An electrical generation system is a set of parts that take external energy or force through a power take-off element, which can be a turbine, blades, or any other means that is joined by a transmission shaft through couplings to a generator, which produces electrical energy. Thus, there are, broadly, three components for such a system, namely, an power take-off element, a coupling element, and a generator. FIG. 1 illustrates, by way of example and not by way of limitation, three such components, namely, a turbine 10, a coupling 12 and a generator 14.

Electric motors and generators are, therefore, conventionally composed of two essential parts, a stationary part and a rotating part. FIG. 2 illustrates, by way of example and not by way of limitation, a generator 14 having a housing and, within the housing, a rotating part or rotor 16 and a stationary part or stator 18. The rotor or rotating part has been conventionally referred to as the inductor and rotates, for example, in response to rotational energy from the coupling that results from rotational forces from the power element such as a turbine. The rotor typically includes permanent magnets. The stator is traditionally positioned to surround the rotor, when viewed in cross-section, and includes induction coils. The rotation of the rotor magnetically induces an electric current in the coils.

### DESCRIPTION OF THE PRIOR ART

U.S. Pat. Nos. 4,302,693 and 4,339,874 describe flux concentration rotors but do not provide details of the nature of the stator.

European patent application EP-A-0 872 943 describes a rotating electrical machine in which the rotor comprises magnets on the surface of the rotor and the magnetic circuit of the stator receives individual coils as is conventional. Such a machine is not intended to rotate at high rotational speeds because the currents induced at the surface of the rotor at high speeds tend to heat up the magnets, which are not resistant to high temperatures. By way of example, when these magnets are mounted on the surface without being split, the limit speed of rotation is for example of the order of 200 revs/mm for a 16-pole rotor and 400 revs/mm for an 8-pole motor poles, both of which is insufficient for certain applications. One solution to avoid heating the magnets is to split them, but this complicates the manufacture and increases the cost. In addition, the number of magnets to be provided, in the event of splitting, increases with the square of the speed, so that in addition to its cost, this solution becomes physically inapplicable as soon as the requested speed is relatively high, for example greater than a few thousand revs/mm.

European patent Application EP-A-0 823 771 describes a stator comprising a winding on each tooth. The magnetic circuit of the stator is formed by the assembly of sectors defining air gaps at mid-width of the notches. In such a machine, a reluctance effect is sought and obtained by seeking to maximize the difference Ld−Lq, where Ld is the inductance in the direct axis and Lq is the inductance in the quadrature axis (conventional notations). The downside is to generate torque ripples. Furthermore, the division into sectors as described in application EP-A-0 823 771 weakens the stator because the bearing surfaces of the sectors on each other are relatively narrow. On the other hand, the magnetic flux crosses as many air gaps as there are sectors, reducing the efficiency of the machine. Furthermore, in the machine described in application EP-A-0 872 943, magnets dedicated solely to detecting the rotation of the rotor are mounted thereon, which complicates the manufacture of the rotor. The stator exerts diametrically opposed, rotating radial forces on the rotor. This results in a mechanical stress on the stator tending to ovalize it, which generates vibrations and noise. Finally, the width of the teeth is constant, which presents at least two drawbacks. On the one hand, the magnetic material of the stator is liable to be saturated at the base of the teeth. On the other hand, the replacement of a coil requires a new impregnation of the stator, in order to immobilize the coil correctly on the stator, and the machine cannot be repaired on site and must return to the manufacturer.

U.S. Pat. No. 5,829,120 describes a flux-concentrating rotor, comprising connections between the pole pieces to facilitate the positioning of the magnets. Such a rotor is relatively difficult to manufacture, due to the presence of narrow portions of sheets on the outside of the rotor, to hold the pole pieces, in certain embodiments.

U.S. Pat. No. 5,091,668 also describes a flux-concentrating rotor, in which the pole pieces are connected to the rotor shaft by dovetail connections and the magnets are parallelepipedal. Such a rotor is not suitable for high rotational speeds, since the centrifugal force tends to separate the regions of each pole piece which grip the corresponding rib formed on the shaft. It is therefore necessary to engage the pole pieces on bars integral with the shaft. However, such a solution is not entirely satisfactory, since, apart from the fact that it complicates the manufacture of the rotor, the bars tend to flex when the length of the rotor is long and/or the speed high.

European Patent N^{º} 1152516 B1 illustrates a “Rotating electrical machine with rotor flux concentration and wound stator teeth.” The device illustrated in this European Patent includes a toothed ring that serves to apply force to another gear ring. The function, therefore, is not an electric motor and generator. The operation of the device in EP Patent is different because no permanent magnets are used. Instead, the device has two sections of temporary magnets comprising two sets of coils on the inside as on its periphery. An electric charge must be applied for the device to function thus the form and application of the device are completely different.

The entire contents of each of the foregoing prior art documents is hereby incorporated by reference.

In the prior art, the movement of the rotor induces the electrical current in the stator. The rotor is the interior component. The rotor is the “inductor” and current is “induced” in the surrounding stator.

### SUMMARY

One characteristic that differentiates the present invention from the prior art is that the basic functions of conventional systems are the same, but as contrasted to the prior art, integrated into a single piece of equipment. One characteristic that differentiates the present invention from the prior art is that the stator is located at the center, mounted on the shaft, and this induced-shaft set remains static. The rotor (inductor), which is formed by a series of permanent magnets and is connected to the power take-off elements, is on the periphery and spins or rotates. Thus, while a magnetic field is formed between the inductor (rotating component) and the induced elements (stationary component) by means of rotation, the location of the components of the generator of the present invention are reversed, i.e., the external part rotates while the internal part is stationary. In other words, the rotor surrounds the stator which is a reverse arrangement from the prior art, which makes it unique.

The inductor is made up of a circular external housing, which in its external part has a series of channels that serve as anchoring means to the force receiving elements, according to each application. In the internal part a series of channels are included that serve as anchoring means to a series of permanent magnets distributed axially, perpendicular to the axis. It should be noted that, in this case, the inductor rotates parallel or frontally to the armature. The other series of magnets are installed on the side covers.

The rotor it is formed by an internal circular housing in which a plurality of coils positioned equidistantly and perpendicularly to the axis are housed.

It should be noted that the rotor (induced) is common for all applications. The only variable are the power take-off elements and the corresponding outer casing of the inductor and the static shaft.

### BRIEF DESCRIPTION OF THE DRAWINGS

The foregoing characteristics, features, benefits and advantages of the present invention, together with other benefits and advantages will become apparent to one skilled in the art upon reading the following detailed description of the invention including the accompanying drawings. In the drawings, wherein like reference numerals identify corresponding components:

FIG. 1 is a schematic front view of a traditional generator structure in accordance with the prior art;

FIG. 2 shows a side elevational view of a traditional generator structure in accordance with the prior art;

FIG. 3 schematically shows the main components of an reverse generator in accordance with the present invention;

FIG. 4, consists of FIGS. 4A through 4D in which FIG. 4A and FIG. 4B, are front and side elevation views, respectively, of a radial configuration of the induced part of the reverse generator in accordance with the present invention and in which:

FIG. 4C is a perspective view of the radial configuration of the induced part of the reverse generator in accordance with the present invention;

FIG. 4D is an exploded view of the radial configuration of the induced part of the reverse generator in accordance with the present invention;

FIG. 5, consisting of FIG. 5A and FIG. 5B are perspective and front elevation views, respectively, of a radial configuration of the inductor part of the reverse generator in accordance with the present invention;

FIG. 6, consisting of FIG. 6A and FIG. 6B are perspective and front elevation views, respectively, of an induced-inductor assembly of a radial configuration of the reverse generator in accordance with the present invention;

FIG. 7 is a front elevation view of an inductor housing;

FIG. 8 is a perspective view of an inductor housing;

FIG. 9 is a top plan view of a wind embodiment of an external housing;

FIG. 10 is a perspective view of a wind embodiment of an external housing;

FIG. 11 consists of FIGS. 11A through 11F, in which FIG. 11A, FIG. 11B and FIG. 11C are front elevation, top plan and bottom plan views, respectively, of a wind blade used in a wind-based application, and in which:

FIG. 11D and FIG. 11E are partial side elevational and partial perspective views, respectively, of a wind blade used in wind-based applications, and in which:

FIG. 11F is a partial perspective view of the housing of FIGS. 9-10 with the wind blades of FIGS. 11A-E attached thereto;

FIG. 12, consisting of FIG. 12A, FIG. 12B and FIG. 12C are front elevation, side elevation and perspective views, respectively, of a scoop or wind blade that may be used such as in aeronautic and thermoelectric applications;

FIG. 13 is a perspective view of a scoop of FIGS. 12A-12C;

FIG. 14, consisting of FIG. 14A, FIG. 14B and FIG. 14C are a front elevation, side elevational and perspective views, respectively, of a scoop that may be used as the power-take-off elements in hydroelectric applications;

FIG. 15, consisting of FIG. 15A and FIG. 15B are a front elevational and perspective views, respectively, of a separator to be inserted into the periphery of the outer case between paddles and scoops to maintain a suitable separation therebetween such as in aeronautical, thermoelectric, and hydroelectric applications;

FIG. 16, consisting of FIG. 16A, FIG. 16B and FIG. 16C are end elevational, side elevational and perspective views, respectively of permanent magnets that may be used in the reverse generator in accordance with the present invention;

FIG. 17, consisting of FIG. 17A and FIG. 17B are front elevational and perspective views, respectively, of an induced element of the present reverse generator;

FIG. 18, consisting of FIG. 18A, FIG. 18B and FIG. 18C are a front elevational view, a right end elevational view, and a perspective view, respectively, of a static shaft on whose center an entire system may be supported;

FIG. 19, consisting of FIG. 19A, FIG. 19B and FIG. 19C are a front elevational view, a right end or right-side elevational view, and a perspective view, respectively of an embodiment of a static shaft that may be used on wind applications on whose center an entire system may be supported;

FIG. 20, consisting of FIG. 20A, FIG. 20B, FIG. 20C and FIG. 20D are a front elevational view, a top plan view, a right-side elevational view, and a perspective view, respectively, of a base on which coils may be fixed;

FIG. 21, consisting of FIG. 21 A, FIG. 21B, FIG. 21C and FIG. 21D are various views of an exemplary coil 32;

FIG. 22, consisting of FIG. 22A and FIG. 22B are a front elevation view and a perspective view, respectively, of one form of an axial induced-inductor assembly in accordance with the present invention;

FIG. 23, consisting of FIG. 23A, FIG. 23B and FIG. 23C are a front elevation view, a side elevation view and a perspective view, respectively, of one form of an aeronautical and thermoelectric assembly of the reverse generator in accordance with the present invention;

FIG. 24, consisting of FIGS. 24A, FIG. 24B and FIG. 24C are a front elevation view, a side elevation view and a perspective view, respectively, of one form of a thermoelectric assembly of the reverse generator in accordance with the present invention; and

FIG. 25, consisting of FIG. 25A and FIG. 25B are a front elevation view and a perspective view, respectively, of a radial-radial or double-radial configuration.

### DETAILED DESCRIPTION OF THE EMBODIMENTS

The present invention relates to an reverse electric generator in which the physical position of the induced and inductor elements are reversed in comparison with the conventional equipment, i.e., the interior component is the stationary component, or stator, and the surrounding component is the rotating component, or rotor. The present invention may work as a generator to produce direct current (DC), as an alternator to produce alternating current (AC), and as an electric motor. Every time the term “reverse generator” is used, it is to be understood that all the previous alternatives are included. The current generated by the reverse generator is connected by cables or wires from the coils of the stator to a utilization device in the same manner as in a conventional system, the difference being the physical location of the stator relative to the rotor.

The present invention has applications for generation of electrical power in numerous environments. These include, but are not limited to, electrically powered vehicles, hybrid electrical vehicles, electrically powered ships and planes, and land-based uses that are considered static in nature, e.g., to provide power for residential, commercial and industrial purposes. The foregoing is to be interpreted as illustrative and not to be considered limiting.

Forces may be supplied to the rotatory portion of the reverse generator from air currents, windmills, moving water and the like. Again, the foregoing is to be interpreted as illustrative and not to be considered limiting. It should be further understood that each of the examples or embodiments are intended to be illustrative, exemplary, and non-limiting.

Another characteristic that differentiates the present invention from the prior art is that the above-mentioned different functions are integrated into a single device. Another characteristic is that the stator (induced) is located in the center, mounted on the shaft, and this induced-shaft assembly remains static, while the rotor (inductor), which is formed by a series of permanent magnets and power take-off elements located on the periphery, is the physical component that rotates, unlike all other generators or electric motors in which the internal part rotates. Although the principles of operation are the same, that is, forming a magnetic field between the inductor and the armature (stator coils) through rotation, the components of the present reverse generator rotate reversely, which makes it unique in its operation, configuration and structure.

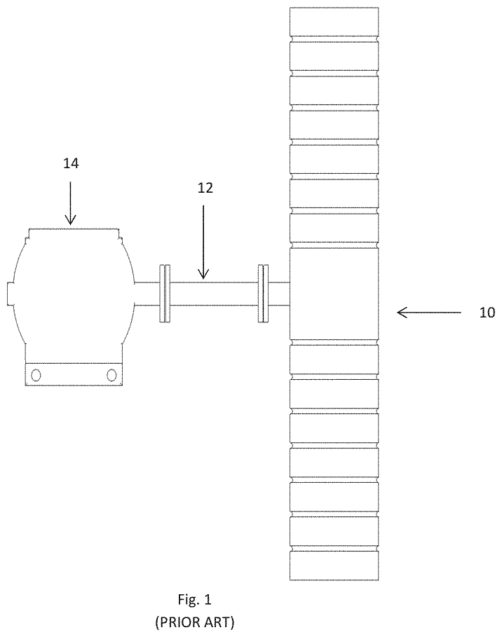

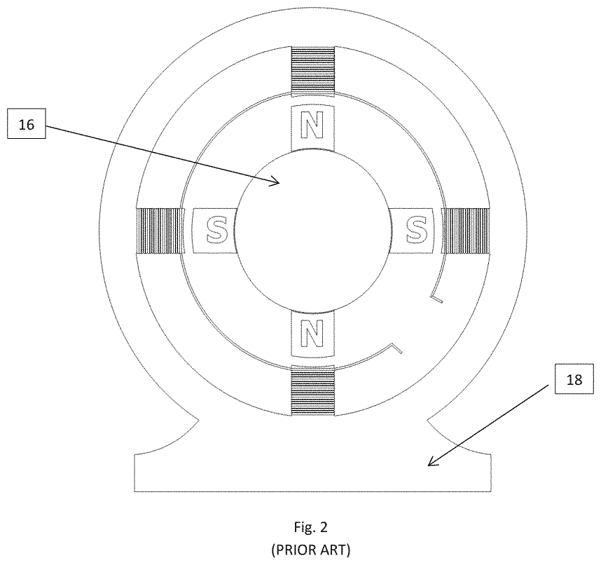

FIGS. 1 and 2 illustrate conventional prior art systems in which a physical power source such as a turbine 10 provides a rotational output. The turbine, of course may be driven by steam as is conventional. The rotational output of the turbine is coupled, for example by a coupling to a shaft 12 received within a rotor in a generator 14. The interior rotor 16 is surrounded by a peripheral stator 18 in which an electric current is magnetically induced by the rotation of the internal rotor 16 which, as just explained, may be an extension of the output shaft of the turbine. The rotor “rotates” and thus “induces” the electrical current which is “induced” in the surrounding “stationary” stator.

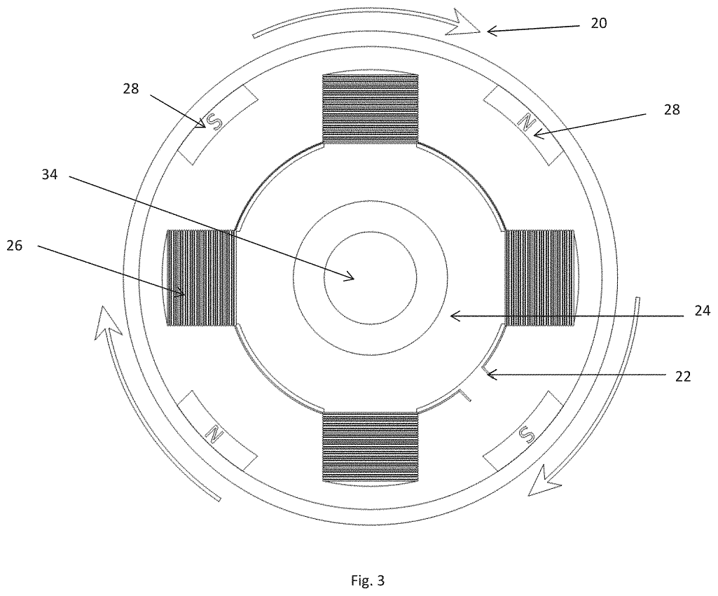

FIG. 3 illustrates, in general, the principles used in an reverse generator in accordance with the present invention. An elongated housing 20, circular in a side elevation view, houses an interior elongated stator 22. The stator, which is formed as an elongated shaft of circular cross-section, is static or stationary. The ends of a stator shaft 34 extend outwardly from the housing 20. The stator is surrounded by a rotor or rotational inductor 24, and rotates to induce the electrical power in the stationary rotor. The stator shaft is surrounded (as illustrated in a side elevation view) by multiple coils 26 equidistant from each other relative to the periphery of the shaft, i.e., the curvilinear distance between any two coils is the same. Permanent magnets 28 are provided for the rotor 16.

Since the reverse generator can produce single-phase and three-phase DC and AC current, all the connections between the coils and from the coils to a utilization device or end-user will not be described in detail, as that, per se, is all well known in the art.

The reverse generator, like any generator, alternator or electric motor, is made up of two essential components, the rotor (inductor element) and the stator (induced element).

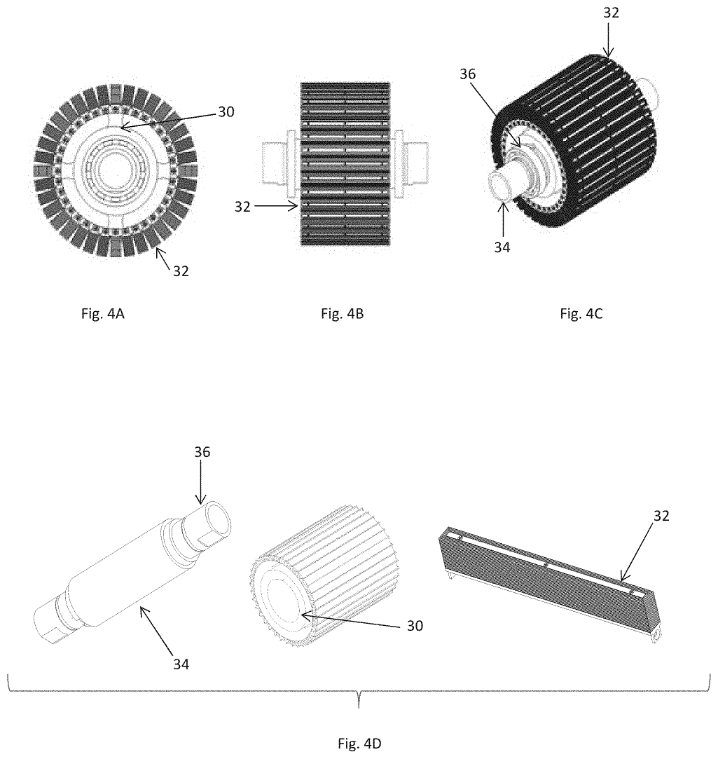

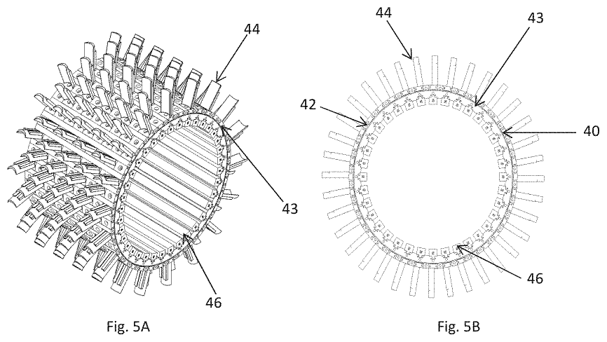

Referring next to FIG. 4, further details of an embodiment of an reverse generator based on the principles described in connection with FIG. 3 will now be described in greater detail. The induced element or stator includes an internal circular housing 30. A series of coils 32 are anchored to the housing as part of an armature or stator framework. A static or fixed support shaft 34, which does not rotate, is positioned within the housing and is mounted on bearings 36, and these bearings permit rotation of the rotor and its components relative to the fixed shaft. The components of the device of FIG. 4 are illustrated in an exploded perspective view in FIG. 4D including the stator housing 30, stator coils 32 and shaft 34 but with the bearings omitted.

The inductor component or rotational part of the reverse generator will now be described. The inductor component is illustrated in FIG. 5 as having a circular external housing 40. The exterior of the housing 40 includes a series of exterior longitudinal channels 42 to which force receiving elements 44 (as hereafter described) are attached. The force receiving elements may be selected for increased efficiency based on the proposed specific use and operation of the reverse generator as will be described in greater detail. The interior of the rotor housing 40 includes a series of interior longitudinal channels 46 in which are secured a series of permanent rotor magnets 48.

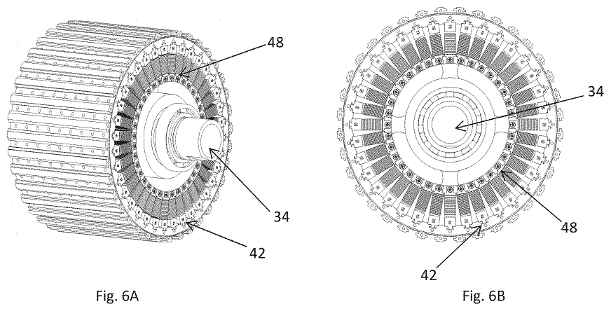

FIG. 6 further illustrates the reverse generator including the rotor mounted relative to the internal stator shaft 34 and the interior permanent magnets 48 mounted in the interior channels of the rotor. Other numerals from FIG. 4 and FIG. 5 have been omitted from FIG. 6 for clarity.

The use of an armature or coils as an induced element, e.g., “stator coils 32” and the use of magnets for an inductor element, e.g., “rotor magnets 48” are common among all the embodiments and the foregoing is therefore to be considered as non-limiting. The variables among the embodiments include power take-off elements, the outer casing of the inductor and the static shaft as will be further described below.

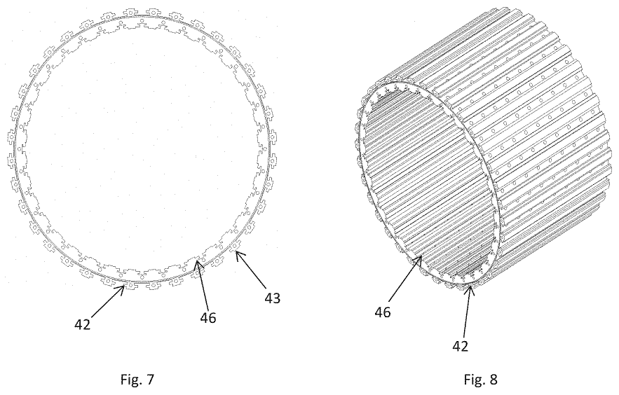

Referring next to FIGS. 7 and 8, the inductor, the outermost rotating component of the reverse generator includes a series of external, parallel, spaced-apart longitudinal channels 42. The channels are defined as the spaces between adjacent T-shaped spacers or projections 43. The channels receive and hold or retain the power take-off elements, in certain embodiments, as will be described below. These power take-off elements, also referred to as force receiving elements, receive mechanical energy to produce a torque which causes the inductor element to rotate. That rotation induces the electrical current in the coils of the interior stator. The rotor housing also includes the interior channels 46 which retains the permanent magnets. Various details of the inductor or rotor housing have been omitted in FIG. 7 and FIG. 8 for clarity.

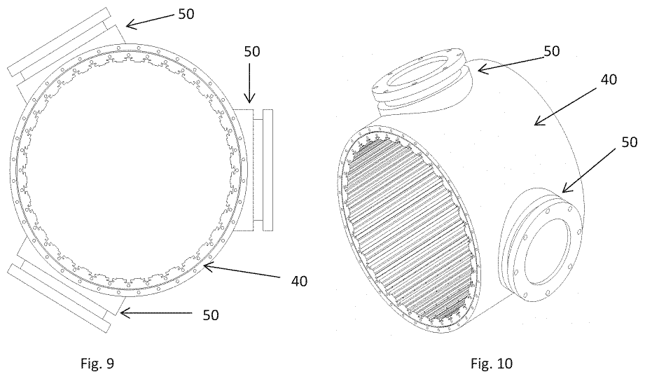

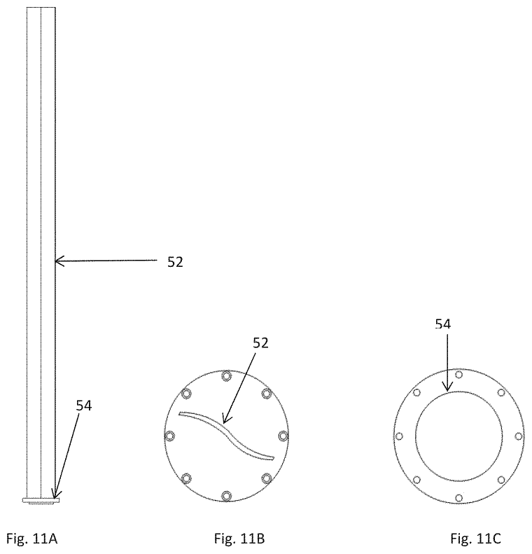

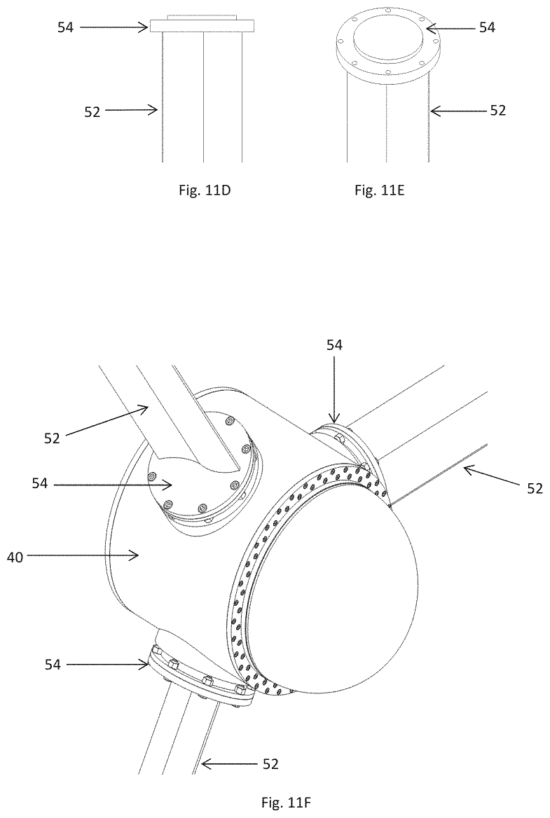

Referring next to FIG. 9, FIG. 10, and FIG. 11, an embodiment utilizing the basic principles of an reverse generator having a particular utility in wind-based applications will now be explained. In this embodiment, instead of exterior rotor channels, a series of seats or anchoring bases 50 are provided around the periphery of the rotor housing for wind paddle power take off elements are provided. The seats or anchoring bases 50 are spaced around the periphery of the rotor housing 40 and open radially outwardly.

Details of the wind paddles or wind blades will now be described. The wind blades or paddles are elongated double-curved or S-shaped scoops or blades 52. One end of the blade is coupled or attached to a circular base 54. The base 54 is secured to the anchoring base 50 on the rotor housing. The opposite end of the blade 52 extends radially outwardly from the rotor housing 40. In operation, each blade functions as a power take-off or force receiving element. Each blade will respond to the force of air currents and thus respond to the energy from the wind. The wind force against the blades 52 causes rotation of the inductor or rotor 24 relative to the induced element or stator 22.

For both aeronautical and thermoelectrical applications, a different configurate of scoop or blades and a different configuration for attaching the blades to the rotor housing is preferred although it should be appreciated that the blade configuration of FIGS. 9-FIG. 11 may be used in those applications as well.

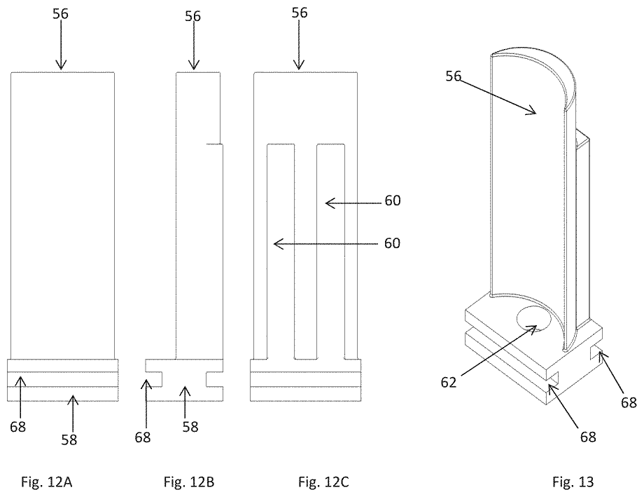

Referring to FIG. 12 and FIG. 13, a power take-off or force receiving element or blade or scoop 56 is formed an elongated curved or generally C-shaped member. One end of the blade 56 is secured to a generally rectangular base 58. The blade may include one or more elongated reinforcing members 60 on the exterior side of the blade curve. The base may include an aperture 62 through which a fastener such as a bolt may be inserted to secure the blade to the exterior of the inductor element housing. The blade or scoop 56 will be position on the exterior of the rotor housing to respond to physical forces, e.g., air, thus resulting in rotation of the rotor housing.

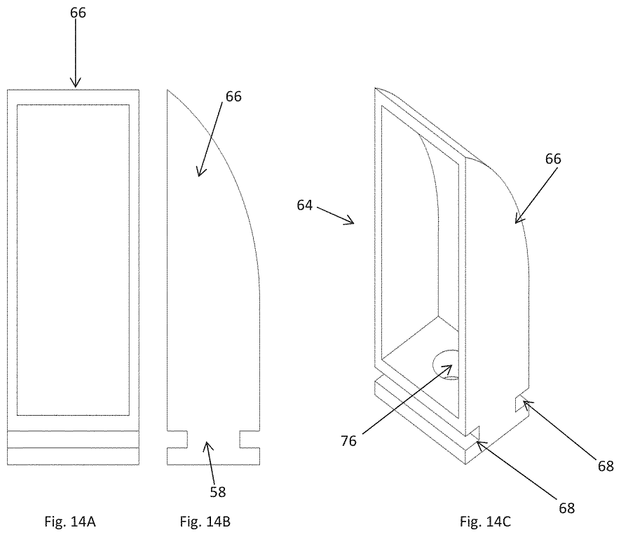

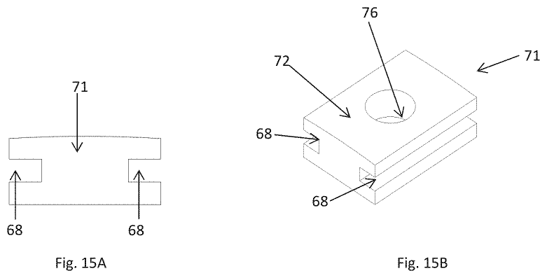

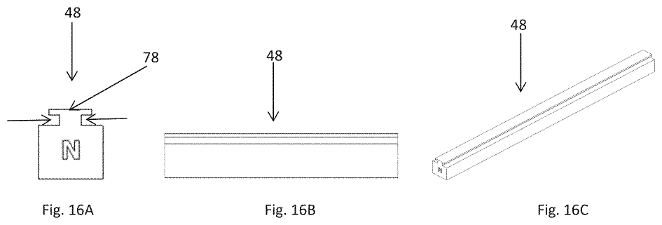

Referring next to FIG. 14, another alternative form of wind blade or air scoop 64 is illustrated. The air scoop or blade 64, which may be used in wind applications, is an elongated, generally rectangular frame member, in front elevation view, with an open interior. The exterior rear 66 of the scoop or blade is curved and configured as the upper half of a semi-circle when viewed in side elevation. The lower end of the blade or scoop is attached to a rectangular base 58. The base includes opposed side grooves 68 with the grooves opening outwardly along the entire length of the base. One of the grooves opens rearwardly of the scoop in the direction of the curved side 66 and the other groove opens forwardly of the scoop so that the groove opening is visible in the front elevation view of the scoop. An aperture 62 is provided in the base through which a fastener such as a bolt may be inserted to secure the blade to the exterior of the inductor element housing.

As described previously with respect to FIG. 5, the longitudinal rotor exterior channels 42 are spaced apart circumferentially a sufficient distance so as to receive the force receiving elements 44. The channels are separated by inverted “T” shaped spacers. If the base 58 is are utilized, the top legs of the “T” shaped spacers 43 will engage the interior of the grooves 68 to secure the blades or scoops in place. This may be in addition to or instead of the use of fasteners through the apertures 62.

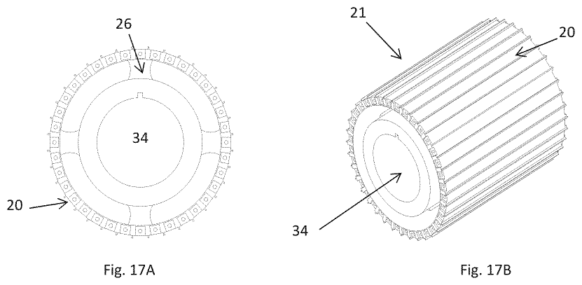

The exterior channels 42 are spaced apart a sufficient distance from each other around the periphery of the inductor or rotor element so that the power take off elements are not in contact with each other. In addition, removable spacers are provided to be used within the channels so that the power take off elements are spaced apart longitudinally. An example of a spacer 71 is illustrated in FIG. 15 as a rectangular block or base 72 with a central aperture 76 therethrough. The base of the spacer includes opposed grooves 68 as just described with reference to FIG. 14. The grooves receive the top legs of the “T” shaped spacers. Thus, in the same way that scoops and paddles are inserted in the channels 42 and retained by the legs of the spacers 43, the longitudinal spacers 72 may be inserted and retained in the channels 42.

In the wind power application, as previously explained, the external anchoring bases 58 are not used, rather, anchoring bases 50 for the blades or wind blades are preferred as illustrated, for example, in FIG. 10.

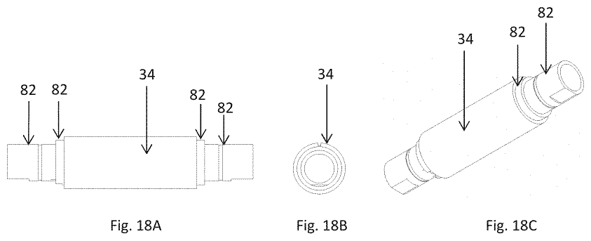

The interior of the inductor or rotor housing is also provided with channels 46 that may be of the same configuration and use as exterior rotor housing channels 42 except that the permanent magnets 48 (see FIG. 6) are retained within the interior clamping channels. Each interior permanent magnet 48, as illustrated in greater detail in FIG. 16, is formed as an elongated member, preferably of neodymium, of generally square cross-section and includes an upper projection 78 with opposed longitudinal grooves 80 defined between the projection and the main portion of the magnet. The grooves 80 open in opposite directions.

The longitudinal interior channels 46 are separated by T-shaped projections and the top legs of the T-shaped projects engage the grooves 80 of the permanent magnets. The permanent magnets are placed peripherally or circumferentially equidistant from each other around the interior circumference of the rotor housing. The separation angle between magnets, in degrees, is 360°÷number of magnets. Thus, for example, if three magnets are used, they are spaced 360°÷3=120° degrees apart. The magnets are self-anchoring or self-fastening within the housing through the use of the grooves 80.

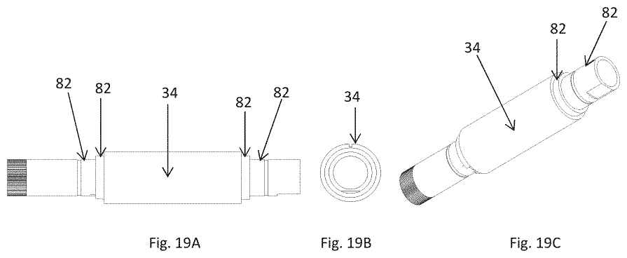

FIGS. 17-19 provide further details of the stator or induced stationary element. The stator or induced stationary element 22 includes an elongated cylindrical (in cross-section) static shaft 34 on which the entire reverse generator system is supported. The shaft 34 is preferably a solid structure of rigid material. It is a stepped shaft 82 in that the diameter is reduced in increments, at both ends of the shaft. The shaft is also provided with seats or channels to anchor the previously-described coils 32 using conventional bolts. The coils 32 are formed by a conductor wound around a laminated core of magnetic steel which in turn is on the base of a coil holder, and these are fastened to the housing by means of clamping bolts. In its center the coils have a hole where the static shaft is housed.

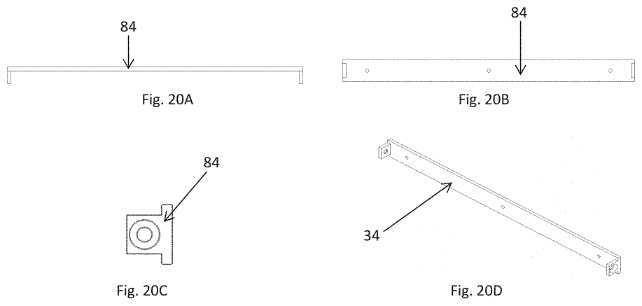

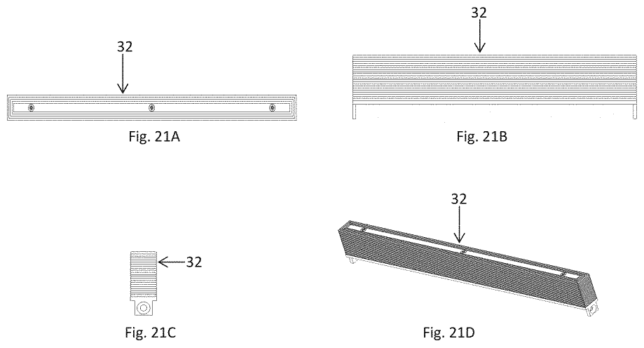

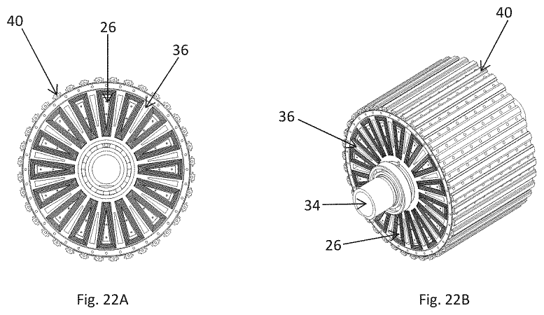

The static shaft 34 is the interior central part of the reverse generator and the entire reverse generator is supported on the ends of the shaft. Bearings are provided on the stepped portions 82 of the shaft to allow for rotation of the rotor part of the reverse generator. The basic concept of bearings to provide for relative rotation between the rotor and stator is, itself, conventional however, in the reverse generator, it is the exterior component, that rotates. FIG. 20 illustrates base 84 on which the coils 32 are mounted. An exemplary coil 32 is described with respect to FIG. 21. The coil 32 includes a coil body that makes up the passive element of the armature. The coil is anchored to the circular internal housing by means of bolts (not illustrated). The coil in turn is attached to the metal base 84 in which there are sheets of ferromagnetic material forming a core, and around it the copper cable that makes up the coil is wound. These coils are spaced at equidistant longitudinally and equiangular circumferentially from each other.

The reverse generator is preferably provided with covers to protect the generator external casing or housing and seals between the generator external casing or housing and the covers all as is conventional. The purpose of the seals is to prevent water or other external agents from entering the reverse generator. The seals are made of flexible synthetic material and the use of seals and covers is conventional in prior art generators.

Referring next to FIG. 22A and FIG. 22B, portions of an assembled reverse generator are illustrated including the rotor housing 40 surrounding, circumferentially, the stator housing 30 which surrounds, circumferentially, the stator shaft 34. Coils 26 are provided on the stator shaft and electrical current is induced in the coils upon rotation of the rotor. The permanent magnets in the rotor, various covers and seals have been omitted for clarity.

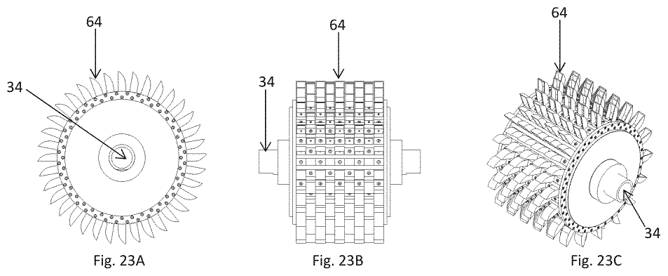

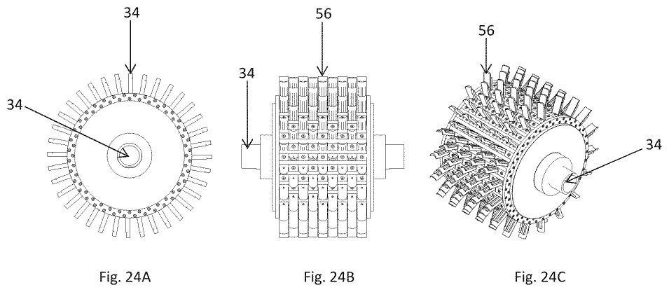

FIG. 23 illustrates portions of an assembled reverse generator with the air scoops or blades 64 of FIG. 14. FIG. 24 illustrates portions of an assembled reverse generator with the air scoops or blades 56 of FIGS. 12 and 13. In each of FIGS. 23 and 24, various references numerals have been omitted for clarity.

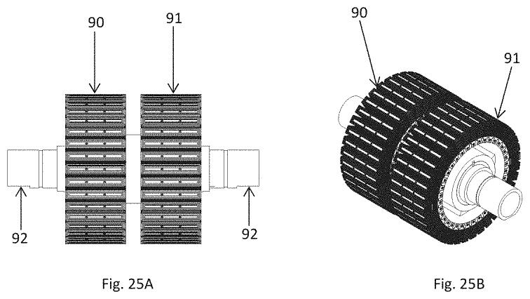

Various additional embodiments of the rotor and stator, consistent with the advantages of the reverse generator, will now be explained. FIG. 25 illustrates a radial-radial or double-radial reverse generator. In the embodiment of FIG. 25, there are two separate axially spaced-apart rotors 90, 91 and a stator. This embodiment allows for the production of different type of current, for example, one for generating a single-phase current and the other for generating a three-phase current. Alternatively, one rotor may be used for generation of direct current (through the use of a AC/DC converter as would be conventional) and the other may be used for generation of alternating current. To better accomplish this, the stator 92 may be formed as two spaced apart stators 92A, 92B electrically separated from each other but on a common shaft.

By way of example and not by way of limitation, a double chamber system similar in concept to FIG. 25 may be utilized where one chamber works as an electric motor and the other chamber works as a direct or alternating current generator. This example may have particular use in electric land vehicles where the system is installed on the wheels and does not have transmission shafts, differential boxes, or transmission, since the wheels are directly installed on the equipment. In this example the reverse generator functions primarily as an electric motor, providing the energy that moves the vehicle, and secondarily works as a generator, when motor stops, thus returning part of the charge to the batteries of the land vehicle. Similarly, the reverse generator may be utilized as an electric motor only, applying an electric load instead of producing electricity, and may be applied as an outboard motor in vessels of various drafts from light boats to larger vessels of large tonnage.

The foregoing is a complete description of a reverse generator. Various changes and modifications may be made by those of ordinary skill in the art based on the explanation given above and particular utilizations of a reverse generator may benefit from such modifications. The invention should be limited only by the scope of the following claims and equivalents thereof.

What is claimed is:

1. An reverse electric power generator comprising:
an elongated stationary shaft of circular cross-section;
an elongated rotatable housing of circular cross-section;
the shaft being mounted generally interiorly of the housing;
the housing being mounted for rotation relative to the shaft;
the housing having permanent magnets secured thereto for rotation with the housing;
the shaft having electrical coils mounted relative thereto; and
at least one power take-off element on the exterior of the housing for receiving non-electrical energy and causing the rotatable housing to rotate in response thereto;
the rotation of the housing for inducing electrical energy in the coils.

2. The reverse electric power generator according to claim 1, further comprising a plurality of power take-off elements spaced equidistant around the exterior of the housing.

3. The reverse electric power generator according to claim 1, further comprising a plurality of power take-off elements longitudinally spaced apart on the exterior of the housing.

4. The reverse electric power generator according to claim 1, wherein the power take-off element is an air scoop.

5. The reverse electric power generator according to claim 1, wherein the power take-off element is a paddle.

6. The reverse electric power generator according to claim 1, wherein the power take-off element is an air blade.

7. The reverse electric power generator according to claim 1, wherein the power take-off element is a longitudinal S-shaped blade.

8. The reverse electric power generator according to claim 1, wherein the power take-off element is a longitudinal C-shaped blade.

9. The reverse electric power generator according to claim 1, wherein the power take-off element causes the housing to rotate in response to movement of water.

10. The reverse electric power generator according to claim 1, wherein the power take-off element causes the housing to rotate in response to changes in temperature.

11. An reverse electric power generator comprising:
an elongated stationary stator; and
an elongated rotor;
the stator mounted interiorly of the rotor; and
the rotor mounted for rotation relative to the stator to induce an electrical current in the stator.
